(19) United States
(12) Patent Application Publication
(10) Pub. No.: US 2013/0134099 A1
(43) Pub. Date: May 30, 2013

(54) STEAM PURIFICATION

(71) Applicant: LANXESS Deutschland GmbH, Leverkusen (DE)

(72) Inventors: Wolfgang Zarges, Cologne (DE); Wolfgang Wambach, Cologne (DE); Pierre Vanhoorne, Monheim (DE); Reinhold Klipper, Cologne (DE); Michael Schelhaas, Cologne (DE)

(73) Assignee: LANXESS DEUTSCHLAND GMBH, Leverkusen (DE)

(21) Appl. No.: 13/681,451

(22) Filed: Nov. 20, 2012

(30) Foreign Application Priority Data
Nov. 24, 2011 (EP) 11190451.2

(51) Int. Cl. B01J 49/00; B01D 24/46

(52) U.S. Cl. CPC B01J 49/0069; B01D 24/46
USPC 210/670; 521/26

(57) ABSTRACT

This invention relates to an improved process for producing weakly acidic cation exchange resins, in particular the purification of weakly acidic cation exchange resins derived from crosslinked poly(acrylonitrile) and also the use of steam for reducing the leaching of weakly acidic cation exchangers and finally a process for increasing the performance of water treatment systems, preferably of tap water treatment systems, using the weakly acidic cation exchangers produced according to the invention.

This invention relates to an improved process for producing weakly acidic cation exchange resins, in particular the purification of weakly acidic cation exchange resins derived from crosslinked poly(acrylonitrile) and also the use of steam for reducing the leaching of weakly acidic cation exchangers and finally a process for increasing the performance of water treatment systems, preferably of drinking water treatment systems, using the weakly acidic cation exchangers produced according to the invention.

Weakly acidic cation exchange resins have important uses in the removal of alkaline earth metal ions, in particular calcium and magnesium, and some metals, in particular lead, mercury, copper, zinc, from tap water. The high ion exchange capacity and exchange selectivity of weakly acidic cation exchange resins are ideal properties in this application. As such, the combination of weakly acidic cation exchange resins with activated carbon in mixed bed systems has found wide use in tap water treatment applications, e.g. water jug filter applications for tap water. It is desirable for the weakly acidic cation exchange resins not to release any extractable materials from the resin into the treated water. These extractable materials are usually by-products from the process for producing the ion exchangers.

The purification of weakly acidic cation exchange resins for removing extractable materials, in particular and uncrosslinked polymer chains, initiator radicals and other impurities, is dependent on an acceptable performance in many end applications. Without careful purification, the resins can release materials into the water to be treated, which leads to foaming, colour changes, odour, high TOC values (total organic carbon values) and other undesirable effects. The phenomenon is known in the art as “leaching”, and the materials released are referred to as “leachables”. The term “leaching” can also be equated with “elution”. A distinction is made between initial and continuous leaching: initial leachables are organic materials which are released by fresh resins after pretreatment and consist of residual products from the production process. These can be monomers, oligomers, polymers, by-products and also production auxiliaries. Initial leaching does not continue for long, just until the residual products have been rinsed from the resin. A continuous leaching process once started can, under extreme conditions, proceed until reduction in the capacity commences and destruction of the resin takes place. The transition to continuous leaching is associated with an attack on the structure of the matrix. Continuous leachables are decomposition products of the exchanger which are produced continuously in each particle. They consist of chain fragments of various lengths in various amounts. (Thesis, R. G. Lamberz, F H Aachen, 2001).

Weakly acidic cation exchange resins are usually produced by suspension polymerization of hydrolysable acrylic monomers, preferably acrylonitrile, methyl acrylate or other acrylate esters, with a suitable crosslinking monomer, preferably divinylbenzene (DVB), trivinylcyclohexane (TVCH), 1,7-octadiene or diethylene glycol divinyl ether. These crosslinked copolymers are then hydrolyzed under either acidic or basic conditions, giving the corresponding polycarboxylic acid products.

Both acid-catalyzed and base-catalyzed hydrolyses of crosslinked poly(acrylonitrile) bead polymer present problems which have to be addressed in the process for producing weakly acidic cation exchange resins. Acid hydrolysis, in particular by sulphuric acid, usually proceeds with considerable evolution of heat, which makes hydrolysis on the industrial scale difficult to control. In addition, large amounts of waste sulphuric acid are produced during the hydrolysis. In addition, the waste sulphuric acid is contaminated by salts, in particular ammonium sulphate, due to the intermediate neutralization of ammonia during the hydrolysis, which results in further time-consuming processing of materials for disposal or reuse.

Alkaline (basic) hydrolysis is usually carried out by contacting the crosslinked poly(acrylonitrile) bead polymer with an aqueous, alcoholic or mixed aqueous-alcoholic alkali metal hydroxide solution at elevated temperatures under reflux or in closed pressure vessels (autoclaves) until hydrolysis is complete. The production of ammonia leads to similar safety issues as were discussed for the acid hydrolysis reaction, namely considerable evolution of heat and the sporadic generation of gaseous ammonia during the hydrolysis.

In a similar way, acid-catalyzed and base-catalyzed hydrolyses of crosslinked poly(alkyl acrylate) materials produce waste streams and by-product contamination, in particular volatile (C₁-C₄)-alcohols and the corresponding ether compounds resulting from the condensation of the alcohols, in the process for producing weakly acidic cation exchange resins.

In addition to the abovementioned safety and environmental issues, which include the production process, the weakly acidic cation exchange resin intermediates obtained have to be elaborately purified in order to remove the by-products produced in the production process. Such purification steps are intended to ensure the quality of weakly acidic cation exchange resin materials which are used in treatment systems for tap water applications. Previous efforts (U.S. Pat. Nos. 3,544,488 and 3,687,912) to minimize the amount of by-products in hydrolyzed poly(acrylonitrile) resins encompass the use of selected auxiliary crosslinkers (in addition to DVB). U.S. Pat. No. 5,175,193 discloses the alkaline hydrolysis of crosslinked poly(acrylonitrile), in which the alkaline hydrolyzing agent and the crosslinked poly(acrylonitrile) are combined only at elevated temperatures, i.e. at above 105° C. However, the resins treated according to the above description further require elaborate purification before they are used in typical tap water applications.

DE 60209309T2 describes a process for treating a WAC (weakly acidic cation exchanger) in the hydrogen form with steam, which increases the uptake capacity of the WAC for trihalomethanes present in the water. However, the large amounts of steam of from 1 to 15 kg of steam per kg of WAC and the long treatment times of the WAC represent an economic disadvantage. A reduction in the TOC release from the WAC is not demonstrated.

The process of the invention overcomes the defects of previous processes for reducing the amount of impurities resulting from the production process in weakly acidic cation exchange resins in their final form and thus reduces the TOC release from the resins which have been treated according to the invention.

The present invention provides a process for purifying weakly acidic cation exchange resins, which comprises: (a) converting of a weakly acidic cation exchange resin which is present essentially in neutralized salt form into a weakly acidic cation exchange resin in hydrogen form by regeneration by means of an acidic regenerating agent, and (b) contacting the weakly acidic cation exchange resin in hydrogen form with from 0.1 to 0.9 kilogram of steam per kilogram of weakly acidic cation exchange resin in the hydrogen form at a resin bed temperature of from 100 to 150° C. for a time of at least one hour.

For clarification, it may be pointed out that all definitions and parameters indicated below in general terms or specified in preferred ranges are encompassed in any combinations by the scope of the present invention.

In a further embodiment, the present invention provides a process for the treatment of water for use as tap water, which comprises contacting the water being treated with a bed of a weakly acidic cation exchange resin which has been purified by the above-described process.

In a further embodiment, the present invention provides the above-described process in which the weakly acidic cation exchange resin is selected from one or more copolymers of crosslinked poly(acrylic acid), crosslinked poly(methacrylic acid), hydrolyzed, crosslinked poly((C₁-C₄)alkyl acrylate) and hydrolyzed, crosslinked poly(acrylonitrile).

The present invention also provides for the use of steam for reducing the leaching from weakly acidic cation exchangers, preferably leaching caused by leachables from copolymers of crosslinked poly(acrylic acid), crosslinked poly(methacrylic acid), hydrolyzed, crosslinked poly((C₁-C₄)alkyl acrylate) and hydrolyzed, crosslinked poly(acrylonitrile). The present invention particularly preferably provides for the abovementioned use, characterized in that from 0.1 to 0.9 kilogram of steam is used per kilogram of weakly acidic cation exchange resin in the hydrogen form at a resin temperature of from 100 to 180° C. for a time of at least one hour.

The present invention also provides a process for increasing the performance of water treatment systems, preferably of tap water treatment systems, characterized in that the water to be treated is brought into contact with a bed of a weakly acidic cation exchange resin, in which the weakly acidic cation exchange resin which is initially present essentially in neutralized salt form has been converted into a weakly acidic cation exchange resin in hydrogen form by regeneration by means of an acidic regenerating agent and has then been purified by means of 0.1 to 0.9 kilogram of steam per kilogram of weakly acidic cation exchange resin in the hydrogen form at a resin bed temperature of from 100 to 180° C. for a time of at least one hour.

In the present invention, an improved process for the effective removal of weakly acidic cation exchange resin intermediates which leads to weakly acidic cation exchange resins which ensure improved performance of water treatment systems has been found. The process of the invention can be employed for weakly acidic cation exchange resins which are derived from crosslinked polycarboxylate resin precursors by either acid hydrolysis or base hydrolysis. The present invention therefore also provides a process for increasing the performance of water treatment systems, preferably of tap water treatment systems, characterized in that the water to be treated is brought into contact with a bed of a weakly acidic cation exchange resin, in which the weakly acidic cation exchange resin which is initially present essentially in neutralized salt form has been converted into a weakly acidic cation exchange resin in the hydrogen form by regeneration by means of an acidic regenerating agent and has then been purified by means of from 0.1 to 0.9 kilogram of steam per kilogram of weakly acidic cation exchange resin in the hydrogen form at a resin bed temperature of from 100 to 180° C. for a time of at least one hour.

The steam treatment to be employed according to the invention at a prescribed point during the processing of a weakly acidic cation exchange resin is critical in order to obtain a weakly acidic cation exchange resin which can be used as a component in tap water treatment systems, e.g. cartridge jug systems.

As used herein, the following terms are characterized by the corresponding definitions unless indicated otherwise in the context. The term “crosslinked polycarboxylate resin precursor” refers to a polymer which can provide a weakly acidic cation exchange resin either by direct copolymerization of acrylic acid or methacrylic acid monomers with crosslinking monomers or by copolymerization of acid precursor monomers, preferably acrylonitrile or (C₁-C₄)-alkyl acrylates, which can subsequently be hydrolyzed to form carboxylic acid groups. The term “copolymer” refers to polymer compositions which contain units of two or more different monomers, including positional isomers.

The following abbreviations are used herein:

WAC=weakly acidic cation exchange resin;

g=gram;

kg=kilogram;

1=litre;

ml=millilitre;

cm=centimetre;

ppb=parts per billion (thousand million), based on the weight/volume;

pressure is in kilopascal (kPa).

Unless indicated otherwise, the ranges indicated are inclusive and combinable; temperatures are reported in degrees Celsius (° C.) and references in respect of percentages (%) are in percent by weight.

The process of the invention can be used for the treatment of WAC(s) which is/are produced by various production processes. Suitable weakly acidic cation exchange resins preferably encompass those which are derived from crosslinked poly(acrylic acid), crosslinked poly(methacrylic acid), hydrolyzed, crosslinked poly((C₁-C₄)-alkyl acrylate) and hydrolyzed, crosslinked poly(acrylonitrile); it is assumed that these polymers can be copolymers comprising one or more acrylic acid, methacrylic acid, (C₁-C₄)-alkyl acrylate and acrylonitrile monomer units in polymerized form. Suitable crosslinkers which are useful in the preparation of the abovementioned crosslinked polymers preferably include aromatic polyvinyl compounds, in particular divinylbenzene, trivinylbenzene, divinyltoluene, divinylpyridine, divinylnaphthalene or divinylxylene, and nonaromatic crosslinking monomers, in particular ethylene glycol diacrylate, ethylene glycol dimethacrylate, trimethylolpropane triacrylate, trimethylolpropane trimethacrylate, diethylene glycol divinyl ether, 1,5-hexadiene, 2,5-dimethyl-1,5-hexadiene, 1,7-octadiene, trivinylcyclohexane or triallyl isocyanurate. The crosslinkers are preferably selected from one or more of divinylbenzene (DVB), trivinylcyclohexane (TVCH), 1,7-octadiene and diethylene glycol divinyl ether, with particular preference being given to using DVB and 1,7-octadiene. The crosslinked polycarboxylate resin precursor usually contains from 0.5 to 40%, preferably from 1 to 25%, particularly preferably from 2 to 20% and very particularly preferably from 3 to 15%, of crosslinker, based on the weight of the crosslinker in the polycarboxylate resin precursor before hydrolysis to the carboxylate form. For example, crosslinked poly(methyl acrylate) or crosslinked poly(acrylonitrile) precursors are subjected to an acid hydrolysis or base hydrolysis in order to obtain the corresponding crosslinked weakly acidic poly(acrylic acid) cation exchange resins.

Although comprehensive descriptions of the hydrolysis of crosslinked poly(acrylonitrile) or poly(acrylate) substrates for providing the corresponding weakly acidic cation exchange resins are available, attention has only occasionally been paid to the washing conditions after the hydrolysis and shortly before provision of the WAC resin in its end form. For example, after-hydrolysis treatments are typically characterized by washing the crosslinked poly(acrylonitrile) intermediate which has been subjected to alkaline hydrolysis, conversion into a hydrogen form by means of excess acid and washing to neutrality (U.S. Pat. No. 3,544,488, 3,687,912 and 5,175,193). In a similar way, the after-hydrolysis treatment of crosslinked poly(acrylate) intermediates which have been subjected to alkaline hydrolysis is characterized by washing with 1N hydrochloric acid (U.S. Pat. No. 4,614,751).

The process of the invention starts out from a WAC which is present essentially in neutralized salt form, i.e. a WAC in which at least about 90% of the carboxylic acid functions are present in salt form. Suitable neutralized salt forms preferably encompass sodium, potassium, lithium or ammonium salts. The WAC is particularly preferably provided in sodium form. The WAC in neutralized salt form can be provided directly from the alkaline hydrolysis reaction of a crosslinked polycarboxylate resin precursor by conversion of the WAC from the hydrogen form (as from the acid hydrolysis of a crosslinked polycarboxylate resin precursor) into the neutralized salt form by conventional regeneration processes (see below) or by means of a conventional regeneration of any available WAC in the hydrogen form into the neutralized salt form. The WAC in neutralized salt form can be converted into the hydrogen form (as described below) or optionally be firstly back-washed into the hydrogen form before the conversion or further be washed with additional water, preferably with water at from ambient temperature to about 90° C. Particular preference is given to washing the WAC in neutralized salt form with water (reverse flow or downflow) at from 60 to 90° C. before conversion into the hydrogen form.

The acidic regenerating agent which is useful in the conversion of the WAC in neutralized salt form into the WAC in the hydrogen form is preferably a strong acid, particularly preferably a mineral acid, very particularly preferably an acid selected from the group consisting of sulphuric acid, hydrochloric acid, phosphoric acid and nitric acid. The acidic regenerating agent is very particularly preferably selected from one or more of sulphuric acid and hydrochloric acid. The regeneration is usually carried out by contacting (downflow or upflow column treatment) the

WAC with an excess of acidic regenerating agent, preferably from 2 to 4 molar equivalents of acidic regenerating agent per WAC equivalent. The acidic regenerating agent solution is usually a dilute aqueous solution of the acid which preferably contains from 0.5 to 20% of acid, particularly preferably from 1 to 15% of acid and very particularly preferably from 2 to 10% of acid, based on the weight of the aqueous solution.

As an alternative, the WAC in neutralized salt form can be converted into the WAC in hydrogen form by regeneration by means of a weak acid having a pK in the range from 3 to 7, preferably from 4 to 7 and particularly preferably from 4 to 6.5 (end values included in each case). Suitable weakly acidic regenerating agents preferably encompass carbonic acid and carboxylic acids, particularly preferably acetic acid, citric acid, maleic acid, lactic acid or mixtures thereof. For use, the weakly acidic regenerating agent is preferably selected from one or more of citric acid and carbonic acid.

A typical regeneration (conversion of the hydrogen form into the sodium form and vice versa) of the WAC comprises treatment with the suitable reagents, usually at temperatures from ambient temperature (room temperature) up to about 90° C., and flow rates of about 1 bed volume (BV) usually up to 10 BV, of the regenerating agent per hour. For example, the conversion of a WAC from the hydrogen form into the sodium form and back into the hydrogen form would usually comprise the following sequence: 4 bed volumes of a 7% strength aqueous sodium hydroxide solution, 2 bed volumes of water, 4 bed volumes of a 7% strength aqueous hydrochloric acid solution and 2 bed volumes of water.

The resin in hydrogen form is then treated with steam at a resin bed temperature of from 100 to 180° C., preferably from 110 to 150° C. and particularly preferably from 120 to 140° C., for at least 1 hour, preferably from 1 to 10 hours, particularly preferably from 1 to 5 hours and very particularly preferably from 2 to 4 hours, giving a WAC which can be used in tap water treatment systems.

It has surprisingly been found that the purifying effect and thus the reduction in the TOC release from the WAC occurs even when using significantly smaller amounts of steam than described in DE 60209309T2. It is particularly surprising that the use of amounts of steam which are smaller than those indicated in DE 60209309T2 gives a purer resin which releases less TOC into the tap water than a resin which has been treated according to the prior art. According to the invention, from 0.1 to 0.9 kg, preferably from 0.3 to 0.9 kg and particularly preferably from 0.5 to 0.9 kg, of steam is used per kg of WAC in the process of the present invention. The steam treatment can conveniently be carried out by feeding pressurized steam into a WAC bed or by external heating of a washing column containing the WAC to be treated. According to the invention, the pressurized steam is introduced at a pressure of from 100 to 7000 kPa (from 15 to 1000 pounds per square inch gauge pressure, psig), preferably from 170 to 3500 kPa (from 25 to 500 psig) and particularly preferably from 240 to 700 kPa (from 35 to 100 psig). The steam treatment can be carried out by bringing the WAC in the hydrogen form into contact with steam in the upflow mode, in the downflow mode (usually in columns) or in batch operation (as in a pressure vessel). The WAC in the hydrogen form is usually isolated by allowing the resin which has been treated with steam to drip until it is free of residual surface water, followed by removal from the reactor.

if the steam treatment is carried out at a temperature of less than about 100° C. or the contact time for the treatment is less than about 1 hour, the finished resin has an unsatisfactory quality. If, for example, only hot water rinsing at a temperature of from 80 to 90° C. is used for treating the WAC in hydrogen form, the WAC contains undesirable extractable residual materials which give the treated resin an undesirable odour.

After the steam treatment and before the WAC is taken from the reactor, the WAC which has been treated according to the invention can optionally be subjected to additional treatments. The WAC which has been treated according to the invention with steam is preferably additionally subjected to a final wash with dilute acid to remove small amounts of basic contaminants from the processing step, which comprises contacting the WAC in hydrogen form in downflow operation with from 2 to 5 bed volumes of dilute acid, preferably aqueous solutions of from 0.05 to 1 N sulphuric acid, hydrochloric acid, phosphoric acid or nitric acid, and then rinsing the WAC in the hydrogen form with water before removal from the apparatus. The optional acid wash preferably involves the use of 1 N sulphuric acid.

Other optional treatments of the finished WAC before removal from the apparatus preferably encompass backflushing to remove fines (small resin particle fouling) and treatment to minimize microbial growth in the finished resin. For example, steam-treated WAC can be subjected to an antimicrobial treatment comprising contacting the WAC in hydrogen form with from 0.4 to 5 g, preferably from 0.5 to 3 g and particularly preferably from 0.7 to 2 g, of antimicrobial agent per kg of the WAC in hydrogen form before removal from the apparatus. The antimicrobial treatment carried out in a preferred embodiment encompasses the use of an antimicrobial agent selected from one or more of the group of peroxides, (C₂-C₃)-alcohols and inorganic chloride salts. Suitable peroxides preferably comprise hydrogen peroxide or peracetic acid. Preferred alcohols are ethanol and isopropanol. Preferred inorganic chloride salts are sodium chloride and potassium chloride. When peroxides are used, the amount used in the antimicrobial treatment is preferably from 0.5 to 1.5 g of peroxide per kg of WAC.

### EXAMPLES

All ratios, parts and percentages are, unless indicated otherwise, by weight and all reagents used have, unless indicated otherwise, a good commercial quality. The abbreviations used in the examples and tables are given below:

BV—bed volume (volume of the ion exchange resin bed, including water in the pores)

WAC—weakly acidic cation exchange resin

meq/g—milliequivalents per gram

meq/ml—milliequivalents per millilitre

A WAC prepared by alkaline hydrolysis of an (acrylonitrile-DVB-1,7-octadiene) copolymer followed by conversion into the hydrogen form by reloading with sulphuric acid was used as resin. It had a moisture retention capacity of 50% and a cation exchange capacity of 10.5 meq/g (4.2 meq/ml).

### Example 1 (Not According to the Invention)

The WAC in hydrogen form was treated with steam according to the prior art at 148° C. using 2.5 kg of steam per kg of resin. The steam-treated resin was then backflushed with deionized water for about 2 hours until it was free of visible fine particles and finally washed in the downflow mode using 6 litres of deionized water per kg of resin for about 2 hours.

### Example 2 (According to the Invention)

The WAC in hydrogen form was treated with steam according to the invention at 148° C. using 0.9 kg of steam per kg of resin. The steam-treated resin was then backflushed with deionized water for about 2 hours until it was free of visible fine particles and finally washed in the downflow mode using 6 litres of deionized water per kg of resin for about 2 hours.

### Example 3

The effectiveness of the purification process of the invention was tested by measuring the TOC release from the WAC into tap water (as a measure of the amount of impurities remaining in the resin).

The results are shown in Table 1.

TABLE 1

| | Example 1 | Example 2 |
|---|---|---|
| TOC | (according to DE | (according to the |
| (mg/l) | 60209309T2) | invention) |
| Stability test | 10.20 | 6.47 |
| Yellowing test | 13.90 | 11.49 |
| Leaching test, cold | 6.54 | 4.21 |
| Leaching test, hot | 16.96 | 13.45 |

It can be seen that the TOC release from the resin into the tap water was reduced by up to 36% by means of the process of the invention, even though the amount of steam was reduced by more than a factor of 2, compared to the prior art.

### Measurement Methods

Unless specified otherwise, deionized water is, for the purposes of the present invention, characterized by having a conductivity of from 0.1 to 10 μS, with the content of dissolved or undissolved metal ions not being greater than 1 ppm, preferably not greater than 0.5 ppm, for Fe, Co, Ni, Mo, Cr, Cu as individual components and not greater than 10 ppm, preferably not greater than 1 ppm, for the total of the metals mentioned.

Stability test

50 ml of resin are shaken down and transferred by means of 200 ml of deionized water to a 250 ml glass bottle. The sample is allowed to stand for 5 days and briefly shaken up once a day. The TOC content of the supernatant eluate is determined after 5 days.

Yellowing test

50 ml of resin are shaken down on a vibrating table and transferred to a 250 ml glass bottle. The water is drawn off by means of a suction rod and reduced pressure (the suction rod is a plastic tube which is closed at one open end by a fine woven mesh, about 1 μm mesh opening). The resin sample is washed with 200 ml of deionized (conductivity<1 μS/cm, TOC<300 ppb) water and sucked dry again. This procedure is carried out a total of 3 times. After drawing off the water for the last time, 150 ml of deionized water (conductivity<1 μS/cm, TOC<300 ppb) are introduced into the glass bottle. The bottle is closed and placed in the block heating apparatus at 80° C. for 24 hours.

After the heating period, the TOC content of the supernatant eluate is determined.

### Leaching Test, Cold

85 ml of resin are measured dry into a PE sample beaker (PE=polyethylene) and smoothed by means of a spatula. The sample is transferred by means of 250 ml of UPW (UPW=ultrapure water having a specific resistance of >18 MΩ.cm, TOC<5 ppb) into a 500 ml glass bottle and the bottle is closed. The bottle is shaken vertically on a shaking table at 120 rpm for 1 hour. The eluate is subsequently filtered off with suction on a membrane filter and the TOC content is measured.

### Leaching Test, Hot

85 ml of resin are measured dry into a PE sample beaker and smoothed by means of a spatula. The sample is transferred by means of 150 ml of UPW (specific resistance>18 MΩ.cm, TOC<5 ppb) into a 500 ml conical flask and swirled for 10 seconds. The water is filtered off on a membrane filter and discarded. This procedure is carried out a total of 3 times. 250 ml of UPW are subsequently added to the resin and the conical flask is covered with a clock glass. The flask is placed in a drying oven at 80° C. for a period of 24 hours. After the storage time, the eluate is taken off with suction via a steel frit and cooled to room temperature before the measurement. The TOC content of the eluate is determined.

### TOC Determination

The TOC is a total parameter and indicates the total organically bound carbon in aqueous media in mg/l (ppm). It is determined by means of catalytic decomposition in a Multi N/C 3000 measuring instrument from Analytik Jena.

What is claimed is:

1. Process for purifying weakly acidic cation exchange resins, which comprises:
(a) converting a weakly acidic cation exchange resin which is present essentially in neutralized salt form into a weakly acidic cation exchange resin in hydrogen form by regeneration by means of an acidic regenerating agent, and
(b) contacting the weakly acidic cation exchange resin in hydrogen form with from 0.1 to 0.9 kilogram of steam per kilogram of weakly acidic cation exchange resin in the hydrogen form at a resin bed temperature of from 100 to 180° C. for a time of at least one hour.

2. Process according to claim 1, wherein the weakly acidic cation exchange resin is selected from one or more copolymers of crosslinked poly(acrylic acid), crosslinked poly(methacrylic acid), hydrolysed, crosslinked poly((C₁-C₄)alkyl acrylate) and hydrolysed crosslinked poly(acrylonitrile).

3. Process according to claim 1, wherein the acidic regenerating agent in step (a) is selected from one or more of from 1 to 15% aqueous solutions of sulphuric acid or hydrochloric acid.

4. Process according to claim 1, wherein step (b) is carried out at a resin bed temperature of from 120 to 150° C.

5. Process according to claim 1, wherein the weakly acidic cation exchange resin is brought into contact with from 0.5 to 0.9 kilogram of steam per kilogram of weakly acidic cation exchange resin in the hydrogen form in step (b).

6. Process according to claim 1, wherein the weakly acidic cation exchange resin in the hydrogen form is brought into contact with steam for from 2 to 4 hours in step (b).

7. Process according to claim 1 which further comprises contacting the weakly acidic cationic exchange resin in hydrogen form from step (b) with from 0.4 to 5 gram of an antimicrobial agent, preferably selected from one or more of the group of peroxides, (C₂-C₃)-alcohols and inorganic chloride salts per kilogram of weakly acidic cation exchange resin in hydrogen form.

8. Process according to claim 7, wherein the microbial agent is selected from one or more of hydrogen peroxide, peracetic acid, ethanol, isopropanol, sodium chloride and potassium chloride.

9. Process according to claim 1 which further comprises contacting the weakly acidic cation exchange resin in the hydrogen form from step (b) with from 2 to 5 bed volumes of dilute acid and then washing or rinsing the weakly acidic cation exchange resin in the hydrogen form with water.

10. Process according to claim 9, wherein the dilute acid is selected from one or more of from 0.05 to 1 N aqueous solution of sulphuric acid, hydrochloric acid or phosphoric acid.

11. Process for the treatment of water for use as tap water, which comprises contacting the water to be treated with a bed of a weakly acidic cation exchange resin which has been purified by (a) converting of a weakly acidic cation exchange resin which is present essentially in neutralized salt form into a weakly acidic cation exchange resin in hydrogen form by regeneration by means of an acidic regenerating agent, and (b) contacting the weakly acidic cation exchange resin in hydrogen form with from 0.1 to 0.9 kilogram of steam per kilogram of weakly acidic cation exchange resin in the hydrogen form at a resin bed temperature of from 100 to 180° C. for a time of at least one hour.

12. Use of steam for reducing the leaching from weakly acidic cation exchangers, characterized in that the leachables are leachables from copolymers of crosslinked poly(acrylic acid), crosslinked poly(methacrylic acid), hydrolysed, crosslinked poly((C₁-C₄)-alkyl acrylate) and hydrolysed, crosslinked poly(acrylonitrile).

13. Use according to claim 12, characterized in that from 0.1 to 0.9 kilogram of steam is used per kilogram of weakly acidic cation exchange resin in the hydrogen form at a resin temperature of from 100 to 180° C. for a time of at least one hour.

14. Use according to either claim 12 or 13, characterized in that the steam treatment is carried out by introducing pressurized steam at a pressure of from 100 to 7000 kPa into a bed of a weakly acidic cation exchange resin or by externally heating a washing column containing the weakly acidic cation exchange resin to be treated.

15. Process for increasing the performance of water treatment systems, preferably of tap water treatment systems, characterized in that the water to be treated is brought into contact with a bed of a weakly acidic cation exchange resin, in which the weakly acidic cation exchange resin which is initially present essentially in neutralized salt form has been converted into a weakly acidic cation exchange resin in hydrogen form by regeneration by means of an acidic regenerating agent and has then been purified by means of 0.1 to 0.9 kilogram of steam per kilogram of weakly acidic cation exchange resin in the hydrogen form at a resin bed temperature of from 100 to 180° C. for a time of at least one hour.
